(19) United States
(12) Patent Application Publication
(10) Pub. No.: US 2007/0063014 A1
(43) Pub. Date: Mar. 22, 2007

(54) Time and attendance recording system

(75) Inventors: Simon Plumb, West Yorkshire (GB); Simon Birchall, Rochdale (GB)

Correspondence Address: VENABLE LLP, P.O. BOX 34385, WASHINGTON, DC, 20043-9998, US

(73) Assignee: Time Revolution Limited, West Yorkshire (GB)

(21) Appl. No.: 11/322,253

(22) Filed: Jan. 3, 2006

(30) Foreign Application Priority Data
Sep. 22, 2005 (GB) 05 19356.0

(51) Int. Cl. G06K 7/10; G06F 15/02

(52) U.S. Cl. 235/377; 705/9

(57) ABSTRACT

The present invention provides a method for use in a method for use in a system comprising user identification reading means, a computer operable to communicate with the user identification reading means, the computer having access to scheduled attendance information of at least one employee, a mobile device and wireless communication means allowing the computer and the mobile device to communicate, the method comprising the steps of: comparing actual attendance information against the scheduled attendance information; determining if a least one employee has failed to attend when scheduled; if at least one employee has failed to attend when scheduled, notifying the mobile device.

### FIELD OF THE INVENTION

The present invention relates to an attendance recording system and in particular, although not exclusively, an attendance recording system for employees or contractors.

### BACKGROUND OF THE INVENTION

Presently, many organisations such as companies use an attendance recording system to monitor a working duration and/or attendance of employees or contractors. This is particularly important in situations where the employee is paid hourly, or where a contracted company charges on an hourly basis for the provision of staff.

Typically a known attendance recording system comprises a server 10, at least one identification reading device 20 and a communication means 30 such as a LAN which allow the server and identification reading device 20 to communicate, as shown in FIG. 1.

The identification reading device 20 is arranged to read identification information 40 of an employee or contractor, herein together referred to as an employee. The identification reading device 20 may be, for example, an optical device 20 arranged to read an identification bar code provided on a badge or identification card 40 of the employee. Alternatively, the reading device 20 may be a smart card reader, or other type of identification reading device suitable for reading identification information of an employee.

Normally, an employee has their identification information 40 read at a start and an end of each working period, such as each working day or shift.

When the identification reading device 20 reads the identification information 40, the identification reading device 20 may temporarily store the identification information 40 and time information for later communication to the server 10, such as when the server 10 polls the reading device 20. In this case, the server 10 may communicate with the reading device 20 periodically over the communication means 30, such as a telephone system. The time information relates to a time at which the identification information 40 was read and allows a working duration of the employee to be calculated by the server 10.

Alternatively, the reading device 20 may instantaneously communicate the identification information 40 to the server 10. Here, the information reading device 20 may communicate with the server 10 over a communication means 30 such as a LAN or WAN. In this case, the sever 10 may record the time information corresponding to a time of reading the identification information 40.

Using attendance information comprising identification information 40 and time information, each employee's wages or a charge made by a contractor can be calculated.

However, a problem arises in that if employees do not attend work when scheduled, company management may only become aware of employee non-attendance at a later time. For example, a manager may review the stored attendance information on a weekly basis and become aware that an employee did not attend work on a given day. Alternatively, the manager may be required to manually check that all employees are present during each working period, such as day or shift.

This is particularly troublesome and difficult in a large or spatially distributed company, such as a factory or when contractors, such as contract cleaners, attend the premises of a number of contracting companies. In this case, the manager may travel between sites and management of employees is particularly difficult.

### SUMMARY OF THE INVENTION

An aim of the present invention is to overcome the aforementioned problems.

An aim of the present invention is to provide a system and method which allows the attendance of employees to be monitored in a convenient manner.

An aim of the present invention is to provide a system and method for managing spatially distributed employees or contractors.

According to the present invention there is provided an apparatus and method as set forth in the appended claims. Preferred features of the invention will be apparent from the dependent claims, and the description which follows.

According to a first aspect of the present invention there is provided a method for use in a system comprising user identification reading means, a computer operable to communicate with the user identification reading means, the computer having access to scheduled attendance information of at least one employee, a mobile device and wireless communication means allowing the computer and the mobile device to communicate, the method comprising the steps of: comparing actual attendance information against the scheduled attendance information; determining if a least one employee has failed to attend when scheduled; if at least one employee has failed to attend when scheduled, notifying the mobile device.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 is a schematic view of a prior art time and attendance system; and

FIG. 2 is a schematic view of a time and attendance system according to a preferred embodiment of the present invention.

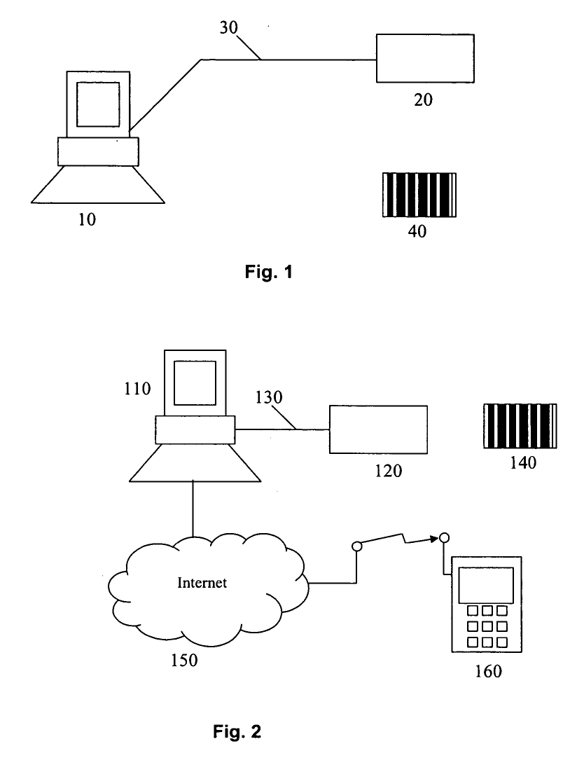

### DETAILED DESCRIPTION OF THE PREFERRED EMBODIMENTS

Referring to FIG. 2, a system according to a preferred embodiment of the present invention comprises a server 110, at least one identification reading device 120, a communication means 130 allowing the server 110 and the identification reading device 120 to communicate, at least one mobile device 160 and wireless communication means 150 for allowing the server 110 and the mobile device 160 to communicate.

As described previously, the identification reading device 120 is arranged to read identification information 140 of an employee or contractor, again referred to together as an employee. The identification reading device 120 can be a magnetic strip reader, arranged to read a magnetic strip on an ID card of an employee, an optical reading device for reading a bar code on an ID card or badge, or any other suitable information reading device.

Typically, an employee will have their identification information 140 read by the device 120 at the start and end of each working period, such as day or shift. However, the present invention is not limited thereto and other designated periodic reading of the identification information 140 may be performed.

In the case of the server 110 periodically polling the identification reading device 120, the server 110 receives attendance information comprising identification information 140 and time information from the identification reading device 120. The time information records the time at which the identification information 140 was read by the identification reading device 120.

Alternatively, the server 110 may receive only identification information 140 from the identification reading device 120 in the case that the identification reading device 120 communicates instantaneously, or nearly instantaneously, with the server 110.

In the case that only identification information 140 is received by the server 110, the server 110 records attendance information comprising time information at the time the identification information is received.

It will be realised that the server 110 may also receive attendance information comprising identification information 140 and time information instantaneously.

The server 110 can access scheduled attendance information which details the expected attendance of each employee. For example, the scheduled attendance information may comprise information that employee number 132 is scheduled to arrive at 9 am on 10 Jul. 2005. The server 110 may comprise a database recording the scheduled attendance information or the server 110 may access a second computer (not shown) which stores the scheduled attendance information.

Periodically, the server 110 compares the scheduled attendance information against the actual attendance information comprising read identification information 140 and time information.

If an employee does not attend work as scheduled, the server 110 notifies the mobile device 160 via the wireless communication means 150. The server may compare scheduled attendance information and the actual attendance information at any desired period, such as every minute, every five minutes, every 10 minutes etc.

If an employee fails to attend work at a scheduled time, the server 110 notifies the mobile device 160. In other words, the server 110 compares the scheduled attendance information and the actual attendance information and, if an employee or contractor has not arrived for work, the server 110 notifies the mobile device.

Preferably, the server 110 allows a predetermined duration of time to elapse between the scheduled attendance time of the employee and notifying the mobile device 160. Advantageously, such a delay reduces the number of notifications sent to the mobile device 160 in the case the employee is merely late. The server 110 may allow a delay of any predetermined duration, such as, for example, 5, 15 or 30 minutes. If identification information 140 of the employee has not been received after the predetermined delay, the server 110 notifies the mobile device 160 that the employee has not attended when scheduled.

In the preferred embodiment, the server 110 sends a textual message to the mobile device 160 via the wireless communication means 150.

In the preferred embodiment, the wireless communication means 150 comprises the Internet and a mobile telephone communication network. Preferably, the textual message is sent as a Short Message Service (SMS) message to the mobile device 160, which is a mobile telephone or Personal Digital Assistant (PDA) having mobile telephone connectivity, such as GSM or GPRS, as will be appreciated by the skilled person.

The server 110 can be arranged to communicate with a mobile device 160 over a mobile telephone network using software, such as a SMS development kit supplied by Simplewire, Inc., 1001 Woodward Ave, Detroit, USA.

Using the SMS development kit provided by SimpleWire Inc., the server 110 communicates with Simplewire's Wireless Messaging Network over the Internet to send a SMS message to the mobile device 160. The SMS message is sent to the mobile device 160 by the Wireless Messaging Network over a mobile telephone network.

The message sent to the mobile device 160 provides details of the employee who has failed to attend when scheduled. In the case of, for example, a factory or contract cleaning environment, when a plurality of employees are scheduled to start work at the same time, the notification may detail a plurality of employees who have failed to attend work at a scheduled time.

Advantageously, the person in possession of the mobile device 160 may then take appropriate action to contact absent staff, arrange replacements or to reallocate attending staff to reduce the impact of absenteeism on a business. Further, such action may be taken shortly after when an employee or employees were due to attend work, without the person or manager being required to examine the actual attendance information on the server 110 or a physically connected computer. Further, the manager may be spatially separated from the business location at which staff attend work or may operate across a plurality of business sites.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method for use in a system comprising user identification reading means, a computer operable to communicate with the user identification reading means, the computer having access to scheduled attendance information of at least one employee, a mobile device and wireless communication means allowing the computer and the mobile device to communicate, the method comprising the steps of:
comparing actual attendance information against the scheduled attendance information;
determining if a least one employee has failed to attend when scheduled;
if at least one employee has failed to attend when scheduled, notifying the mobile device.

2. The method of claim 1, comprising the step of:
receiving at the computer attendance information from the user identification reading means.

3. The method of claim 2, wherein the attendance information comprises employee identification information.

4. The method of claim 3, wherein the attendance information comprises time information corresponding to a time at which employee identification information was read by the user identification reading means.

5. The method of claim 1, comprising recording received attendance information for at least one employee.

6. The method of claim 1, comprising reading scheduled attendance information for at least one employee from a database.

7. The method of claim 1, wherein the database of scheduled attendance information is stored on the computer.

8. The method of claim 1, wherein the comparing step includes comparing scheduled attendance information against actual attendance information for each employee.

9. The method of claim 1, wherein the determining step includes comparing a scheduled attendance time against an actual attendance time for each employee.

10. The method of claim 9, wherein the actual attendance time include information indicating that an employee has not currently attended.

11. The method of claim 10, wherein the determining step includes waiting a predetermined time between the scheduled attendance time before determining that the employee has not attended when scheduled.

12. The method of claim 1, wherein the notifying step comprises sending from the computer to the mobile device a notification message.

13. The method of claim 12, wherein the notification message is sent via the wireless communication means.

14. The method of claim 13, wherein the wireless communication means includes a mobile telephone network.

15. The method of claim 12, wherein the wireless communication means includes the internet.

16. The method of claim 12, wherein the notification message is a Short Message Service (SMS) message.

17. The method of claim 12, wherein the notification message includes employee identification information.

18. The method of claim 17, wherein the notification message includes an employee's name.

19. The method of claim 1, wherein the user identification means comprises a magnetic strip reading device for reading a magnetic strip of an employee identification means.

20. The method of claim 1, wherein the user identification means comprises an optical reading device for reading identification information of an employee.

21. The method of claim 1, wherein the mobile device is a mobile telephone or a pager.

22. The method of claim 1, wherein the mobile device is a personal digital assistant.
